(19) United States
(12) Patent Application Publication
(10) Pub. No.: US 2017/0249878 A1
(43) Pub. Date: Aug. 31, 2017

(54) SPOT MOTION FABRIC PANEL LIGHTING DISPLAY SYSTEM, KIT AND METHOD

(71) Applicant: MOSS HOLDING COMPANY, ELK GROVE VILLAGE, IL (US)

(72) Inventor: ROBERT M. FREY, SALT LAKE CITY, UT (US)

(73) Assignee: MOSS HOLDING COMPANY, ELK GROVE VILLAGE, CA (US)

(21) Appl. No.: 15/444,204

(22) Filed: Feb. 27, 2017

Related U.S. Application Data
(60) Provisional application No. 62/300,051, filed on Feb. 25, 2016.

(51) Int. Cl. G09F 13/04; G09F 19/12; G09F 13/00

(52) U.S. Cl. CPC G09F 13/0413; G09F 13/005; G09F 19/12; G09F 2013/0468; G09F 2013/0463; G09F 2013/222

(57) ABSTRACT

Systems, kits and methods are disclosed which facilitate more dynamic and visually impactful backlighting of fabric panel displays. A perimeter frame assembly has a front edge, a rear edge, and a backlight cavity disposed therebetween. A front perimeter groove extends along the front edge. A display panel includes a flexible textile display substrate removably mounted in tension across the backlight cavity. A planar array of independently-activatable point light elements distributed in mutually-orthogonal X and Y directions is disposed within the backlight cavity at a gap distance from the display substrate. The gap distance is orthogonal to the X and Y directions. A controller is in data communication with the planar array for programmably controlling sequential activation and deactivation of the point light elements independently of one another. The display substrate may have a dye sublimated printed textile graphic thereon, and the point light elements may be white LEDs.

### RELATED APPLICATIONS

This application claims the benefit of U.S. Provisional Application No. 62/300,051 filed Feb. 25, 2016, the content of which is incorporated by this reference its entirety for all purposes as if fully set forth herein.

### TECHNICAL FIELD

The present invention relates generally to the field of portable display systems. More particularly, the invention concerns mechanisms for backlighting a tensioned fabric panel to produce motion graphics on the fabric panel and dynamic backlighting of graphics which are pre-printed on the fabric panel.

### BACKGROUND

Portable fabric panel light boxes are commonly used in the retail, exhibit, corporate and event environments. Graphics are typically printed on the fabric panel, and when the system is assembled and activated, the fabric panel is backlit to highlight the printed graphics. Conventional fabric light box technology typically provides static, white or color backlighting. Advanced controls may allow the brightness of the light to be controlled. However, historically, lighting elements making up a fabric panel backlight subsystem tend to be activated and controlled simultaneously with the same inputs.

Current LED video display technology, like that which is used in major sports stadiums or LED billboards, allows for color video images to be shown on large screens. However, these types of displays tend to be expensive (e.g., $300-$500 per square foot), use a large amount of power, are very heavy, have harsh light when viewed up close, and are generally not very aesthetically pleasing in a portable display. They are both hard to deploy and not very design friendly.

What are needed are improvements in systems, kits and methods for backlighting portable fabric panel display systems in order to provide more dynamic, visually impactful, efficient, and adaptable lighting effects.

### BRIEF DESCRIPTION OF THE DRAWINGS

Further advantages of the present invention may become apparent to those skilled in the art with the benefit of the following detailed description of the preferred embodiments and upon reference to the accompanying drawings in which:

FIG. 1 is diagrammatic partial cross-sectional view of a spot motion fabric panel lighting display system in accordance with one embodiment of the present invention;

FIG. 2 is a diagrammatic perspective view of one example of a perimeter frame assembly with spanner location spacers affixed to a lower horizontal perimeter frame member;

FIG. 3 is a diagrammatic perspective view of a spot motion fabric panel lighting display system with the display panel removed, thereby exposing a planar array of point light elements and an optional audio subsystem;

FIG. 4A is a diagrammatic partial perspective view a light array board being dismounted from frame spanner elements in a spot motion fabric panel lighting display system;

FIG. 4B is a diagrammatic partial perspective view a light array board being lifted from magnetic engagement with a frame spanner element in a spot motion fabric panel lighting display system;

FIG. 5 is a diagrammatic partial magnified perspective view of three light array boards with their adjacent corners magnetically attached to a frame spanner element.

FIG. 6 is a diagrammatic partial perspective view of a lower front corner of a spot motion fabric panel lighting display system with the display panel removed;

FIG. 7 is a diagrammatic partial perspective view of a lower front center portion of a spot motion fabric panel lighting display system with the display panel removed;

FIG. 8 is a diagrammatic partial perspective view of a lower rear portion of a spot motion fabric panel lighting display system with the rear panel removed;

FIG. 9 is a diagrammatic partial perspective view of a lower rear portion of a spot motion fabric panel lighting display system with the rear panel removed, showing a power supply and related features;

FIG. 10 is a diagrammatic partial perspective view of a lower rear portion of a spot motion fabric panel lighting display system with the rear panel removed, showing a controller element and related features;

FIG. 11 is a flow chart illustrating a spot motion fabric panel lighting display method in accordance with an example embodiment of the present invention;

FIGS. 12A-12C are sequential diagrammatic front views of an example spot motion fabric panel lighting display system in operation, wherein a traced motion light graphic is more fully illuminating pre-printed text over a span of time, and a motion light graphic logo is simultaneously being dynamically generated using a welding torch effect; and

FIG. 13 is a diagrammatic perspective view of one example of a spot motion fabric panel lighting display system, wherein the display panel is shown partially removed from engagement with the front perimeter groove to expose the active planar array beneath.

### DETAILED DESCRIPTION OF THE PREFERRED EMBODIMENTS

Referring now to the drawings, like reference numerals designate identical or corresponding features throughout the several views.

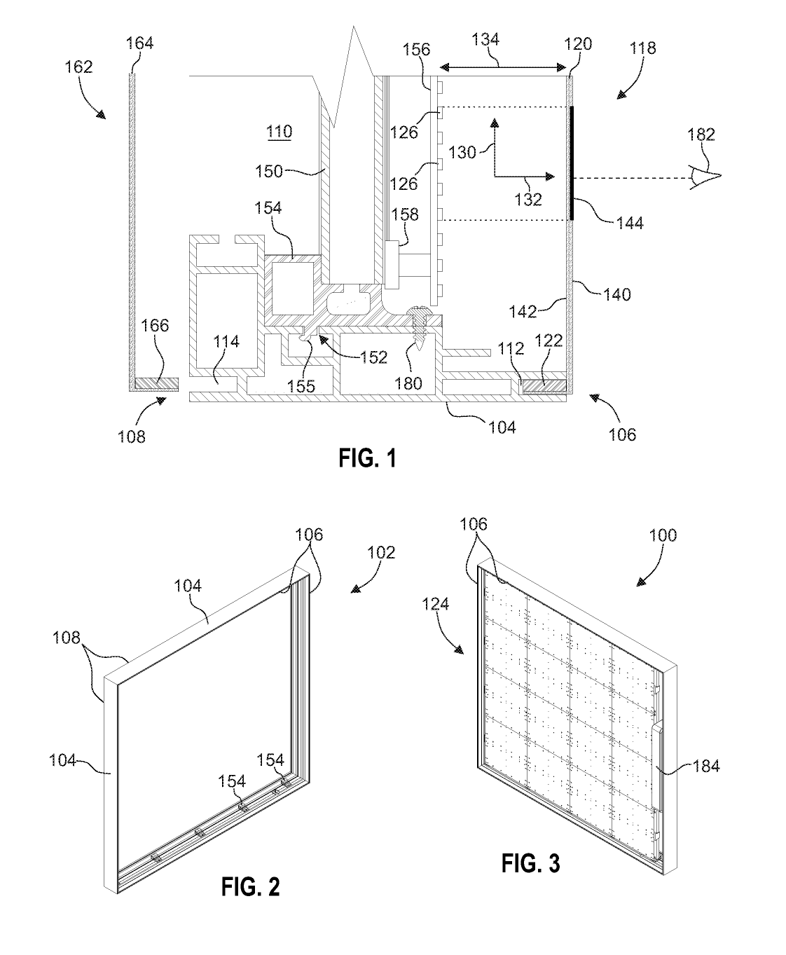

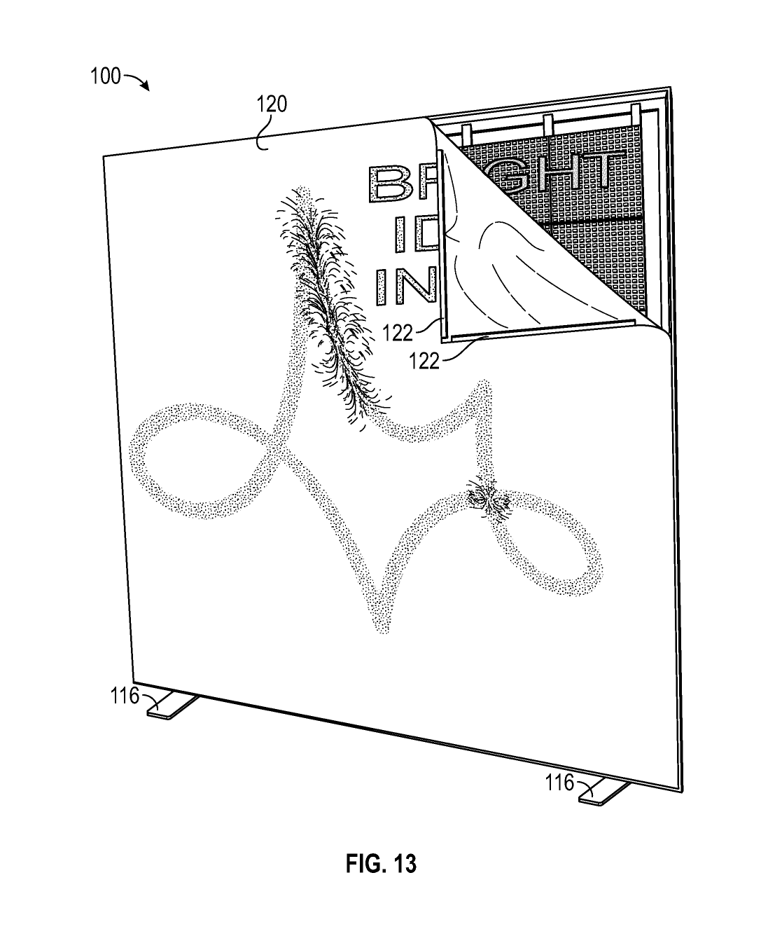

Referring to FIGS. 1-3 and 13, an example embodiment of a spot motion fabric panel lighting display system 100 may comprise a perimeter frame assembly 102, a display panel 118, a planar array 124 of individually-activatable point light elements 126. The perimeter frame assembly 102 may have a front edge portion 106, a rear edge portion 108, and a backlight cavity 110 disposed therebetween. A front perimeter groove 112 may extend along the front edge portion 106. The perimeter frame assembly 102 may be comprised of, for example, extruded aluminum perimeter frame members 104. One or more frame feet 116 may be provided to stabilize the system 100 in an upright operational position.

The display panel 118 may include a flexible textile display substrate 120 and a series of front mounting gaskets 122 attached along a periphery of the display substrate 120. The display panel 118 may be removably mounted in tension across the backlight cavity 110 by way of removable engagement between the front mounting gaskets 122 and the front perimeter groove 112.

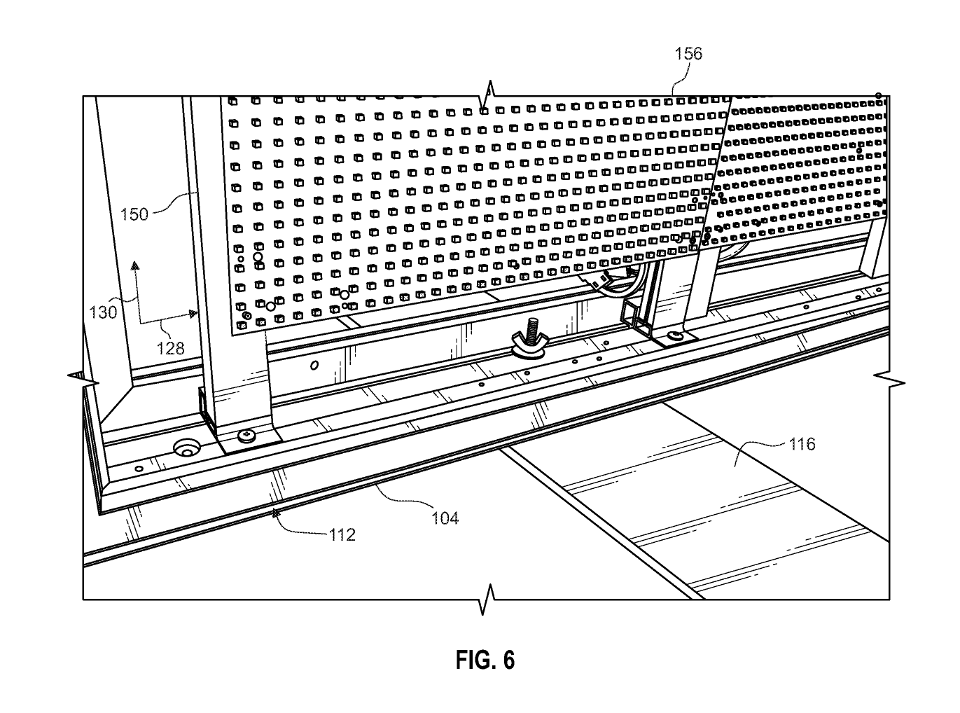

The planar array 124 of independently-activatable point light elements 126 are preferably distributed in mutually-orthogonal X and Y directions (see, e.g., FIG. 6, reference numerals 128 and 130, respectively). The planar array 124 may be disposed within the backlight cavity 110 at a gap distance 134 from the display substrate 120. The gap distance 134 may be in a Z direction 132 orthogonal to the X direction 128 and the Y direction 130.

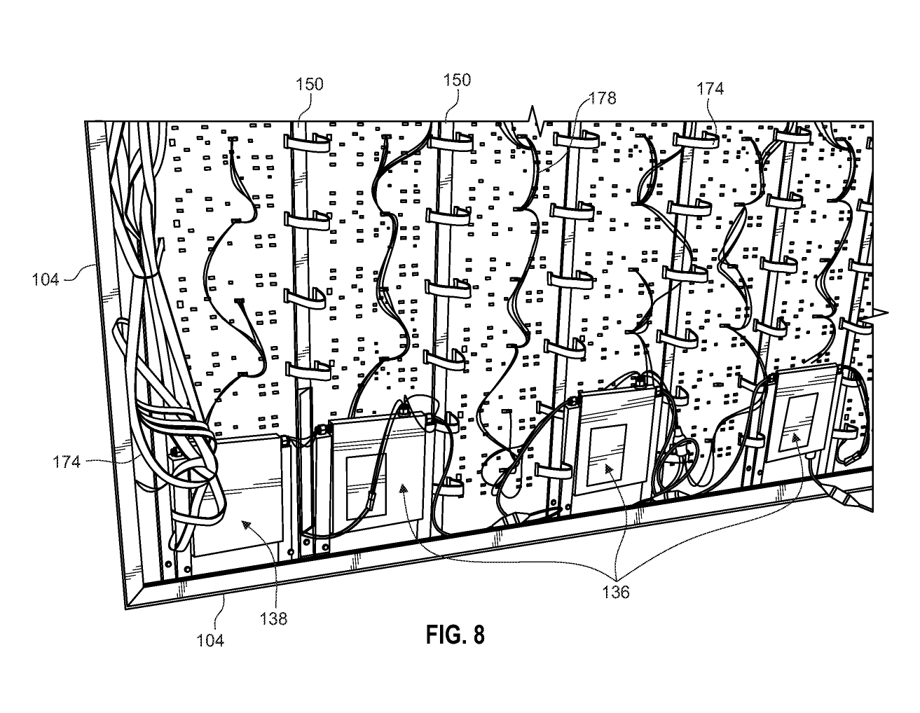

Referring to FIG. 8, a power supply element 136 and a controller element 138 may also be housed within the backlight cavity 110. The controller element 138 may be in data-feed communication with the planar array 124 for controlling sequential activation and deactivation of the point light elements 126 independently of one another.

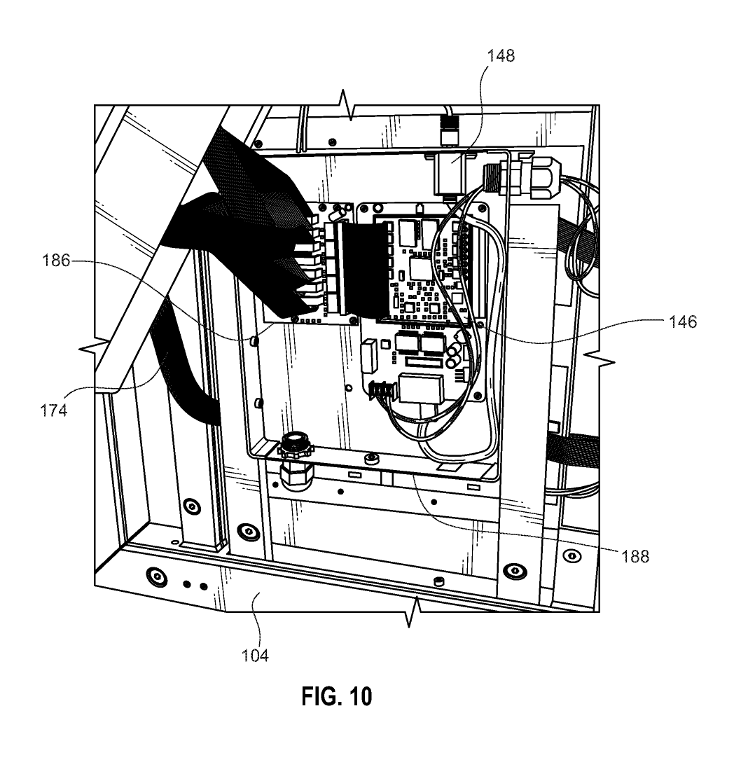

Referring to FIGS. 8 and 10, the controller element may be substantially housed in a controller element box 188 and may include, for example, a data card 146, an Ethernet jack 148, and a communication hub card 186. One or more data cables 174 may be disposed in data communication between the communication hub card 186 and the planar array 124.

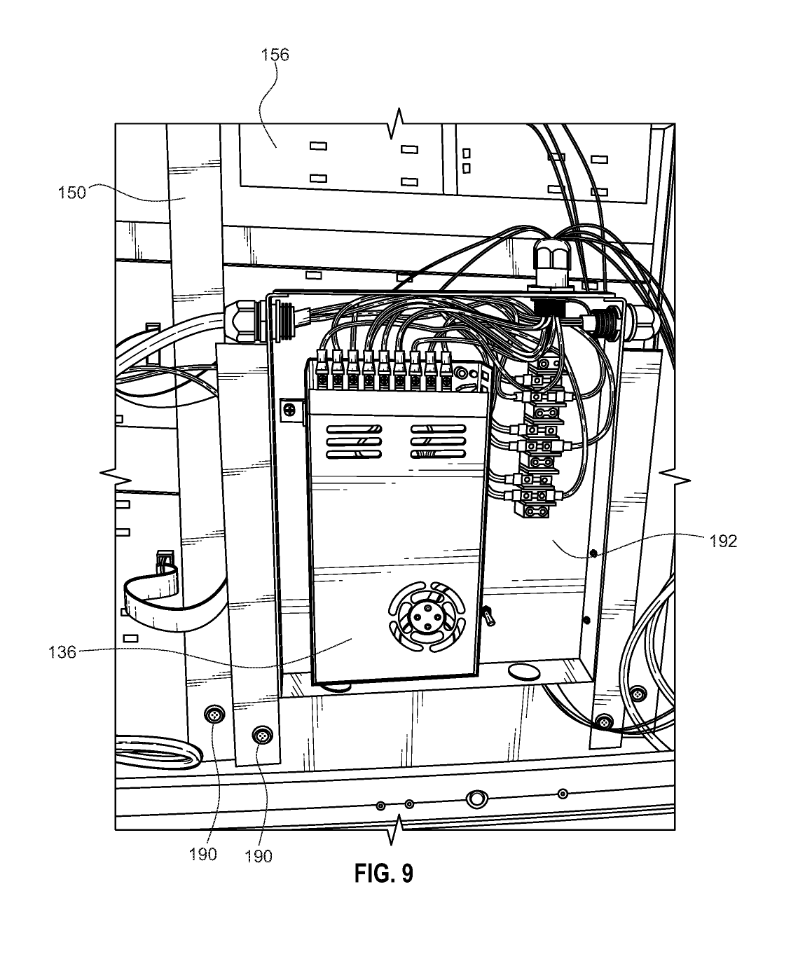

The power supply element 136 may be configured for supplying electrical power to at least the point light elements 126, and typically also to the controller element 138. Referring to FIGS. 8 and 9, the power supply element 136 may substantially housed in one or more power boxes 192, and may include one or more power supplies 136 in electrical power delivering communication with the planar array 124 by way of wiring harnesses 178.

As illustrated in FIG. 9 for example, the controller element box 188 and power boxes 192 may be rigidly affixed to the perimeter frame assembly by way of, for example, frame spanner elements and conventional tension lock elements 190.

Referring to FIG. 1, in certain preferred embodiments of the system 100, the display substrate 120 may have a display face 140 and a back face 142. The display face 140 may be oriented outwardly of the perimeter frame assembly 102 and include a graphic element (represented at 144 for illustration only) printed thereon. In such embodiments, several of the point light elements may be in Z direction 132 alignment with respective portions of the graphic element 144 (see, e.g., the point light elements located between the horizontal dotted lines in FIG. 1).

In particular embodiments of a spot motion fabric panel lighting display system 100, all or most of the point light elements 126 are white LEDs. Moreover, the graphic element 144 may be a dye sublimated printed textile graphic.

Referring to FIGS. 8 and 10, the controller element 138 may include, for example, a data card 146 programmable with a motion file. The motion file may define, for example, sequential activation and deactivation timing for the point light elements 126. Such programmability may be accomplished, for example, by way of an Ethernet jack 148.

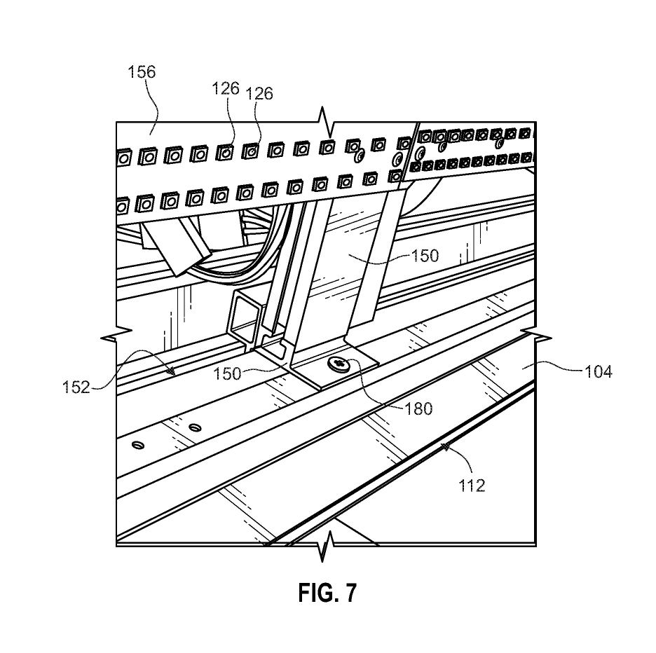

Referring to FIG. 8, certain embodiments of a system 100 may further comprise a plurality of frame spanner elements 150 attached to the perimeter frame assembly 102 within the backlight cavity 110. Referring to FIG. 7, in such embodiments, the perimeter frame assembly 102 may have an inboard spanner groove 152 extending therealong, and the frame spanner elements 150 may be attached to the perimeter frame assembly 102 by way of respective locating spacers 154. The locating spacers 154 maybe preferably by comprised of Nylon similar non-brittle polymers. Referring to FIG. 1, the locating spacers 154 may each have a groove engagement boss 155 or the like which may be receivable by the inboard spanner groove 152. The locating spacers may be secured into position along the inboard spanner groove 152 by way of a fastener 180 such as a screw or rivet.

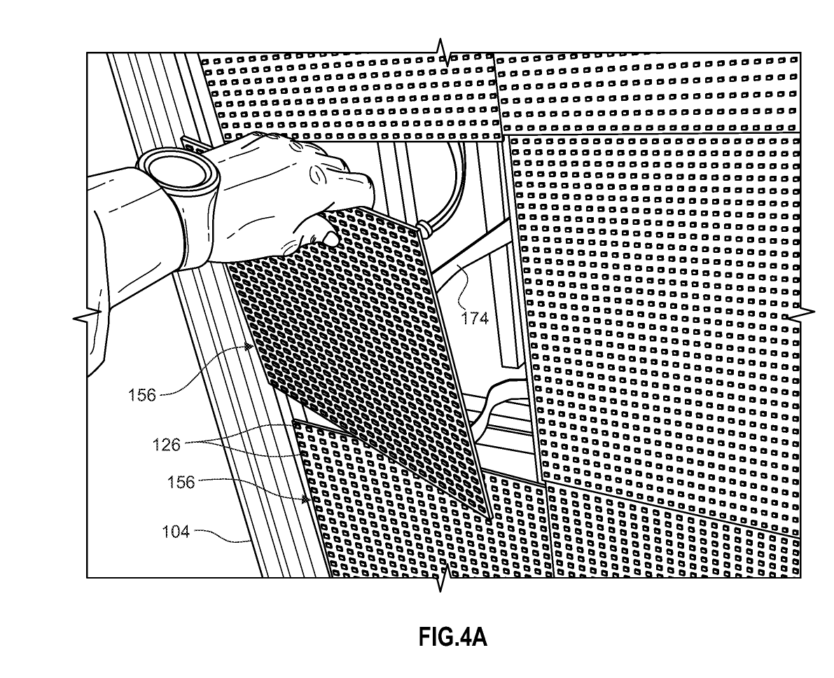

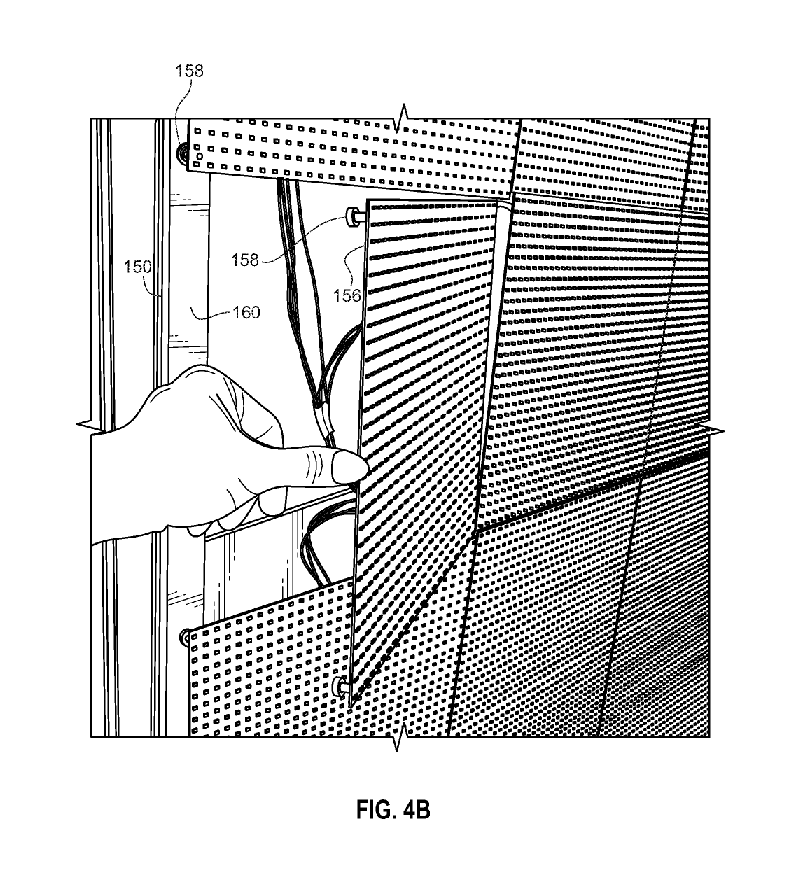

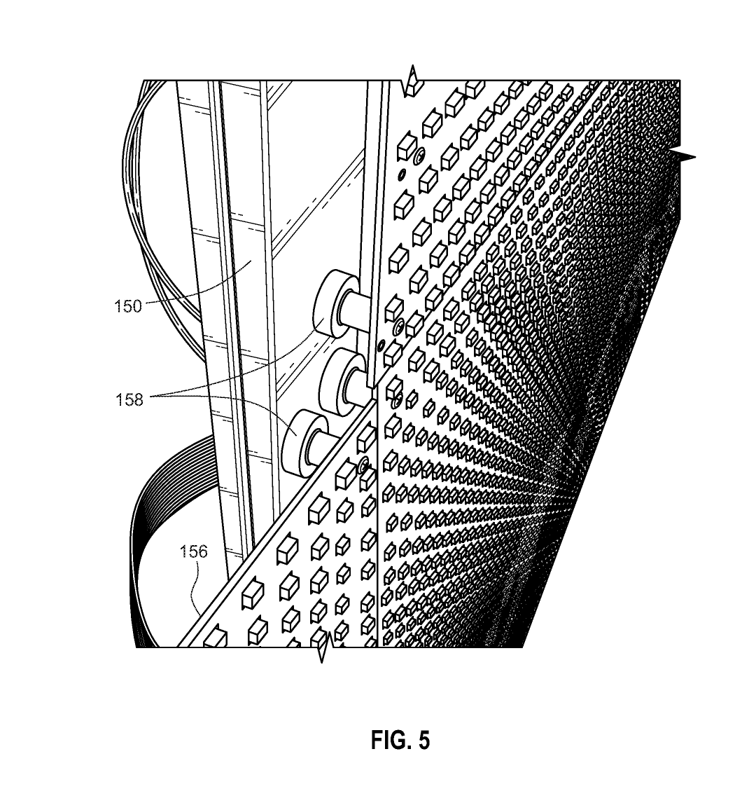

Referring to FIGS. 4A and 4B, the planar array 124 may be comprised of a plurality of light array boards 156 being magnetically attachable to one or more of the frame spanner elements 150 (e.g., by way of magnets 158). In the event the frame spanner elements 150 are comprised of aluminum, they may have steel stripping 160 applied thereto by way of, for example, an adhesive tape or the like. Such steel stripping would allow the magnets 158 to magnetically connect to the respective frame spanner element.

In one example light array board used by the applicant, the board is 320 mm×320 mm with a 32 LED×32 LED board array. Thus, each such board has 1024 individually addressable LEDs. Moreover, each of these example light array boards draws a maximum of 15 watts per board at 5 volts DC.

In particular preferred embodiments of a system 100, the planar array 124, the power supply 136 and the controller element 138 are each mounted within the backlight cavity 110. Moreover, referring to FIG. 3, a system 100 may further comprise an audio subsystem (including a speaker 184) disposed within the backlight cavity 110.

Preferred embodiments of a spot motion fabric panel lighting display system 100 may further comprise a rear panel 162 including a flexible textile rear substrate 164 and a series of rear mounting gaskets 166 attached along a periphery of the rear substrate 164. In such embodiments, a rear perimeter groove 114 may extend along the rear edge portion 108 and the rear panel 162 may be removably mounted in tension across the backlight cavity 110 by way of removable engagement between the rear mounting gaskets 166 and the rear perimeter groove 114.

A spot motion fabric panel lighting display kit may comprise one or more of a plurality of perimeter frame members 104, a display panel 118, a plurality of light array boards 156, as power supply 136 and a controller element 138. The plurality of perimeter frame members 104 are formable into a perimeter frame assembly 102, wherein when the perimeter frame assembly is formed (a) the perimeter frame assembly 104 has a front edge portion 106, a rear edge portion 108, and a backlight cavity 110 disposed therebetween, and (b) a front perimeter groove 112 extends along the front edge portion 106.

The display panel 118 may be removably mountable in tension across the backlight cavity 110 by way of removable engagement between the front mounting gaskets 122 and the front perimeter groove 112.

The plurality of light array boards 156 may be configurable into a planar array 124 of independently-activatable point light elements 126 distributed in mutually-orthogonal X and Y directions. The planar array 124 may be mountable within the backlight cavity 110 at a gap distance 134 from the display substrate 120. The gap distance 134 has a significant impact on the visual effect of the backlighting. This gap distance may be adjustable in certain embodiments of the system. It may also be selectable by adapting the configuration and dimensions of the spanner locating spacers used in the system.

The controller element 138 may be placed in data-feed communication with the planar array 124 for controlling sequential activation and deactivation of the point light elements independently of one another. The power supply element 136 is typically for supplying electrical power to at least the point light elements 126.

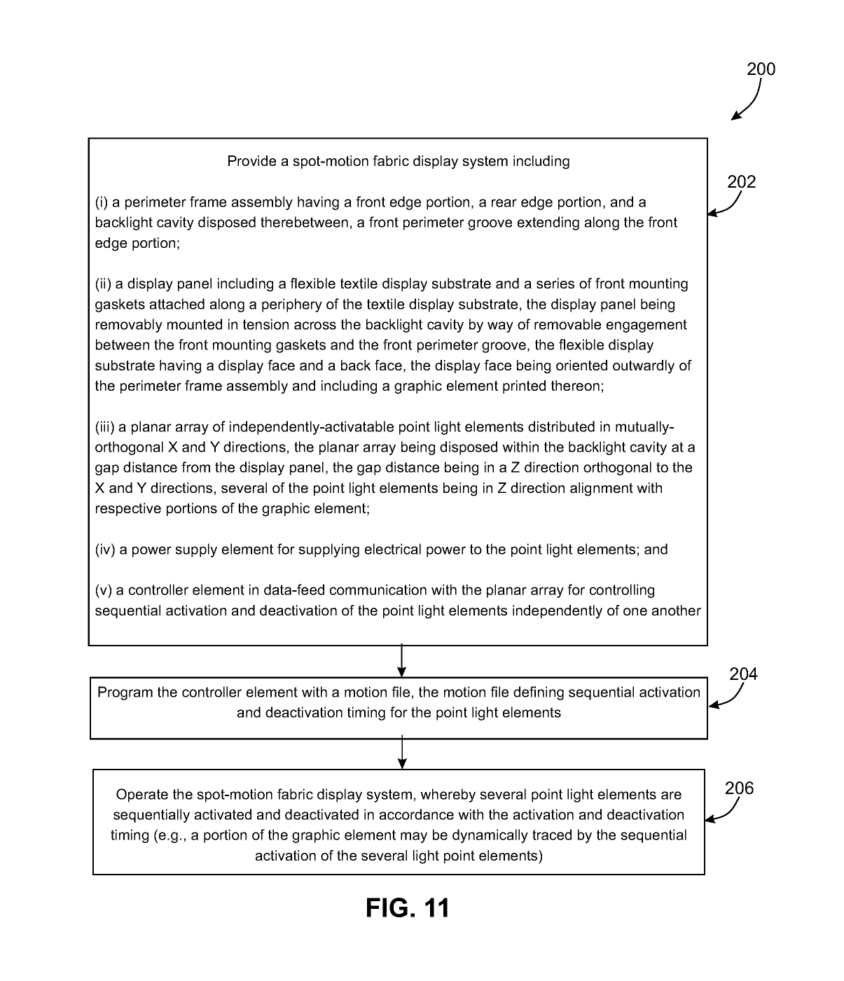

Referring to FIG. 11, a spot motion fabric panel lighting display method 200 may comprise the steps of providing a spot-motion fabric lighting display system in accordance with the present disclosure (see, e.g., step 202), programming the controller element with a motion file (see, e.g., step 204), and operating the spot-motion fabric display system (see, e.g., stop 206).

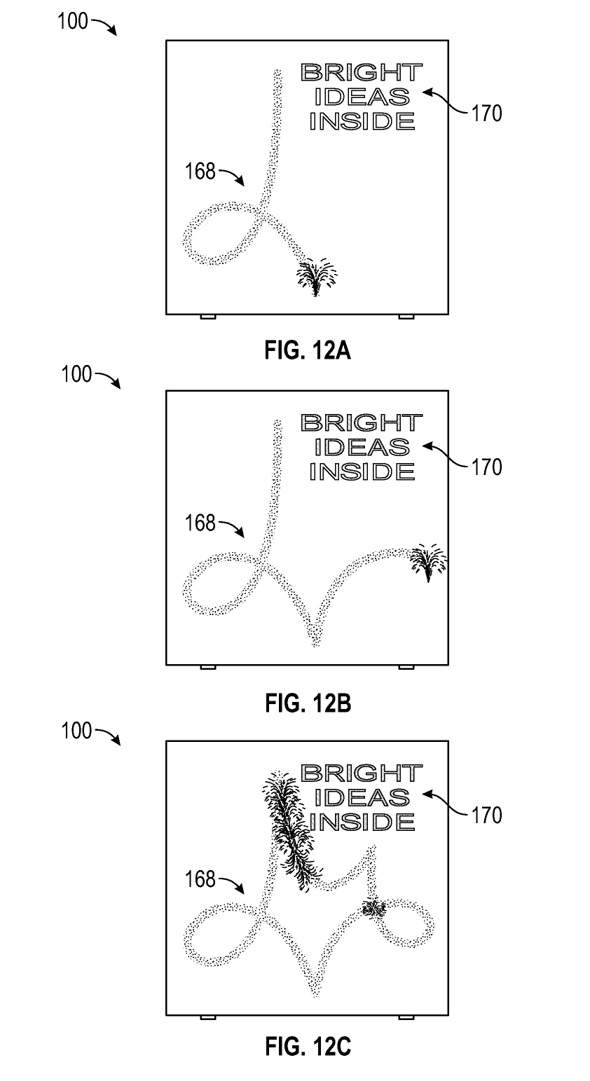

In the step of operating (step 206), at least a portion of the graphic element 144 may be dynamically traced by the sequential activation of several point light elements. See, for example, the traced motion light graphic 170 in FIGS. 12A-12C, wherein the text is graphic element 144 pre-printed on the display face 140, and is being illuminated by respective point light elements 126. The system operation may also be configured to provide a motion light graphic 168 through the display substrate 120 viewable on the display face 140 from a viewpoint 182.

Referring to FIGS. 12A-12C, a series of three drawings illustrates the lighting motion produced by operation of a system in accordance with one embodiment of the present invention. The stylized logo (motion light graphic 168) is being “burned” into the fabric background (e.g., a printed black vertical grain pattern) using a welding torch type effect while at the same time lighting up the text copy in the upper right (e.g., traced motion light graphic 170). This effect may be generated using, for example, reprogrammable white LED back lighting and the front face fabric graphic.

Preferred embodiments of the systems, kits and methods disclosed herein provide the ability to precisely program individual back-lighting LEDs to: (a) match lighting shape to printed graphic images and (b) control the lighting to add motion to the graphic images.

This spot motion technology is both easily deployed and visually pleasing. It creates a whole new level of cost effective, differentiating, visual effect. This may be accomplished. For example, by combining the control of individual white LEDs in a large array format with the color and scale of a dye sublimated, printed textile graphic.

By leveraging the color contained in large, light weight, relatively low cost, dye sublimated printed textile graphics, a white LED backlighting array can be used to dramatically lower the cost, weight, power needs, and install difficulty as compared to full color LED video screens. Moreover, the technology disclosed herein is as visually pleasing as it is easily deployed in a portable display format used across all display system markets (e.g., retail, exhibit, event, and corporate environments).

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A spot motion fabric panel lighting display system comprising:
a perimeter frame assembly having a front edge portion, a rear edge portion, and a backlight cavity disposed therebetween, a front perimeter groove extending along the front edge portion;
a display panel including a flexible textile display substrate and a series of front mounting gaskets attached along a periphery of the display substrate, the display panel being removably mounted in tension across the backlight cavity by way of removable engagement between the front mounting gaskets and the front perimeter groove;
a planar array of independently-activatable point light elements distributed in mutually-orthogonal X and Y directions, the planar array being disposed within the backlight cavity at a gap distance from the display substrate, the gap distance being in a Z direction orthogonal to the X and Y directions;
a controller element in data-feed communication with the planar array for controlling sequential activation and deactivation of the point light elements independently of one another; and
a power supply element for supplying electrical power to at least the point light elements.

2. A spot motion fabric panel lighting display system as defined in claim 1 wherein
(a) the display substrate has a display face and a back face, the display face being oriented outwardly of the perimeter frame assembly and including a graphic element printed thereon, and
(b) several of the point light elements are in Z direction alignment with respective portions of the graphic element.

3. A spot motion fabric panel lighting display system as defined in claim 2 wherein the point light elements are white LEDs and the graphic element is a dye sublimated printed textile graphic.

4. A spot motion fabric panel lighting display system as defined in claim 1 wherein the controller element includes a data card programmable with a motion file, the motion file defining sequential activation and deactivation timing for the point light elements.

5. A spot motion fabric panel lighting display system as defined in claim 4 wherein the programmability is by way of an Ethernet jack.

6. A spot motion fabric panel lighting display system as defined in claim 1 further comprising a plurality of frame spanner elements attached to the perimeter frame assembly within the backlight cavity, wherein
(a) the perimeter frame assembly has an inboard spanner groove extending therealong;
(b) the frame spanner elements are attached to the perimeter frame assembly by way of respective locating spacers, the locating spacers each having a groove engagement boss receivable by the inboard spanner groove; and
(c) the planar array is comprised of a plurality of light array boards being magnetically attachable to one or more of the frame spanner elements.

7. A spot motion fabric panel lighting display system as defined in claim 6 wherein the locating spacers are comprised of Nylon.

8. A spot motion fabric panel lighting display system as defined in claim 1 wherein the planar array, the power supply and the controller element are each mounted within the backlight cavity.

9. A spot motion fabric panel lighting display system as defined in claim 1 further comprising a rear panel including a flexible textile rear substrate and a series of rear mounting gaskets attached along a periphery of the rear substrate;
wherein
(a) a rear perimeter groove extends along the rear edge portion, and
(b) the rear panel is removably mounted in tension across the backlight cavity by way of removable engagement between the rear mounting gaskets and the rear perimeter groove.

10. A spot motion fabric panel lighting display kit comprising:
a plurality of perimeter frame members formable into a perimeter frame assembly, wherein when the perimeter frame assembly is formed
(a) the perimeter frame assembly has a front edge portion, a rear edge portion, and a backlight cavity disposed therebetween, and
(b) a front perimeter groove extends along the front edge portion;
a display panel including a flexible textile display substrate and a series of front mounting gaskets attached along a periphery of the display substrate, the display panel being removably mountable in tension across the backlight cavity by way of removable engagement between the front mounting gaskets and the front perimeter groove;
a plurality of light array boards configurable into a planar array of independently-activatable point light elements distributed in mutually-orthogonal X and Y directions, wherein the planar array is mountable within the backlight cavity at a gap distance from the display substrate, the gap distance being in a Z direction orthogonal to the X and Y directions;
a controller element in data-feed communication with the planar array for controlling sequential activation and deactivation of the point light elements independently of one another; and
a power supply element for supplying electrical power to at least the point light elements.

11. A spot motion fabric panel lighting display kit as defined in claim 10 wherein
(a) the display substrate has a display face and a back face, the display face including a graphic element printed thereon; and
(b) the display panel is configured so that when mounted in tension across the backlight cavity
(i) the display face is oriented outwardly of the perimeter frame assembly, and
(ii) several of the point light elements are in Z direction alignment with respective portions of the traceably-lightable graphic element.

12. A spot motion fabric panel lighting display kit as defined in claim 11 wherein the point light elements are white LEDs and the graphic element is a dye sublimated printed textile graphic.

13. A spot motion fabric panel lighting display kit as defined in claim 10 wherein the controller element includes a data card programmable with a motion file, the motion file defining sequential activation and deactivation timing for the point light elements.

14. A spot motion fabric panel lighting display kit as defined in claim 10 further comprising a plurality of frame spanner elements attachable to the perimeter frame assembly within the backlight cavity, wherein
(a) when formed, the perimeter frame assembly has an inboard spanner groove extending therealong;
(b) the frame spanner elements are attachable to the perimeter frame assembly by way of respective locating spacers, the locating spacers each having a groove engagement boss receivable by the inboard spanner groove; and
(c) the planar array is comprised of a plurality of light array boards being magnetically attachable to one or more of the frame spanner elements.

15. A spot motion fabric panel lighting display kit as defined in claim 14 wherein the locating spacers are comprised of Nylon.

16. A spot motion fabric panel lighting display kit as defined in claim 10 wherein the planar array, the power supply and the controller element are each mountable within the backlight cavity.

17. A spot motion fabric panel lighting display kit as defined in claim 10 further comprising a rear panel including a flexible textile rear substrate and a series of rear mounting gaskets attached along a periphery of the rear substrate;
wherein when the perimeter frame assembly is formed
(a) a rear perimeter groove extends along the rear edge portion, and
(b) the rear panel is removably mountable in tension across the backlight cavity by way of removable engagement between the rear mounting gaskets and the rear perimeter groove.

18. A spot motion fabric panel lighting display method comprising:
providing a spot-motion fabric lighting display system including
(i) a perimeter frame assembly having a front edge portion, a rear edge portion, and a backlight cavity disposed therebetween, a front perimeter groove extending along the front edge portion;
(ii) a display panel including a flexible textile display substrate and a series of front mounting gaskets attached along a periphery of the display substrate, the display panel being removably mounted in tension across the backlight cavity by way of removable engagement between the front mounting gaskets and the front perimeter groove, the display substrate having a display face and a back face, the display face being oriented outwardly of the perimeter frame assembly and including a graphic element printed thereon;
(iii) a planar array of independently-activatable point light elements distributed in mutually-orthogonal X and Y directions, the planar array being disposed within the backlight cavity at a gap distance from the display substrate, the gap distance being in a Z direction orthogonal to the X and Y directions, several of the point light elements being in Z direction alignment with respective portions of the graphic element;
(iv) a controller element in data-feed communication with the planar array for controlling sequential activation and deactivation of the point light elements independently of one another; and
(v) a power supply element for supplying electrical power to at least the point light elements;
programming the controller element with a motion file, the motion file defining sequential activation and deactivation timing for the point light elements; and
operating the spot-motion fabric display system, whereby several point light elements are sequentially activated and deactivated in accordance with the activation and deactivation timing.

19. A spot motion fabric panel lighting display method as defined in claim 18 wherein
In the step of operating, at least a portion of the graphic element is dynamically traced by the sequential activation of the several point light elements.

20. A spot motion fabric panel lighting display method as defined in claim 18 wherein the point light elements are white LEDs and the graphic element is a dye sublimated printed textile graphic.
